(19) United States
(12) Patent Application Publication
(10) Pub. No.: US 2006/0209365 A1
(43) Pub. Date: Sep. 21, 2006

(54) Contact image scanning module having multiple light sources

(75) Inventors: Pen-Jung Lee, Sindian City (TW); Chi-Cheng Wang, Sindian City (TW)

Correspondence Address: HDSL, 4331 STEVENS BATTLE LANE, FAIRFAX, VA, 22033, US

(73) Assignee: CREATIVE SENSOR INC.

(21) Appl. No.: 11/082,842

(22) Filed: Mar. 18, 2005

(51) Int. Cl. H04N 1/40

(52) U.S. Cl. 358/486; 358/471

(57) ABSTRACT

A contact image scanning module having multiple light sources. The contact image scanning module employs two light source groups of different properties and a switching control circuit that controls the two light sources to provide different scanning speeds when scanning different objects. The light sources shine light on the object to be scanned and generate a reflected image. At least a lens element is used for receiving the reflected image and for generating a focused image. At least an optical sensor is employed for receiving the focused image and for converting the optical signals into electronic signals. The printed circuit board is installed on the housing. The contact image scanning module is installed in the housing to form a contact image scanner.

### BACKGROUND OF THE INVENTION

The present invention relates generally to a contact image scanning module having multiple light sources. More particularly, the present invention is applied to the image scanning of black-and-while and color images, which employs at least two light sources of different properties and switches the light sources using a control circuit to provide various scanning speeds for various objects to be scanned, thereby enhancing the black-and-white scanning speeds.

A typical contact image sensor (CIS) normally shines light on an object to be scanned and focuses the reflected light by a lens group on a charge coupled device (CCD) or a complimentary metal-oxide semiconductor (CMOS) light sensor. The CIS also converts the received optical signals to electronic signals for generating pixel data to record on, output to or transmit to a personal computer. It is often used in a standard or professional scanner, a multi-function business machine, a photocopier, etc.

Conventional contact image sensors 1 are generally divided into two types. One type of them is shown in FIG. 1, which includes a white scanning light source 11, such as a cold cathode fluorescent lamp (CCFL), and an optical sensor 12 disposed on a printed circuit board (PCB) 15. The optical sensor 12 includes a color filter or one of a high brightness optical sensor, such as a monochrome EFL. The object to be scanned 10 is disposed on a piece of glass 13. The white scanning light source 11 is shined on the object to be scanned 10 and reflected to a rod lens 14. An image is then formed on the optical sensor 12. The optical sensor 12 synchronously receives optical signals of red, green and blue (RGB) wavelengths and convents the optical signal into electronic signal for transmitting or outputting to a personal computer.

Another type of conventional contact image sensor 2 shown in FIG. 2 has a similar structure and scanning technology as that shown in FIG. 1. The conventional contact image sensor 2 also includes a scanning light source 21, an optical sensor 22 disposed on a PCB 25, a piece of glass 23 for disposing thereon an object 10 to be scanned, and a rod lens 24. The primary feature of the present type is in that the scanning light source employs a point light source 21, such as a light emitting diode, and sequentially emits light of RGB wavelengths. The emitted light is transmitted through a lightguide and shined on the object to be scanned 10. Next, the light is reflected to a rod lens 24 forming a image on the light sensor 22. The optical signal is ten converted to electronic signals, which is transmitted or output to a personal computer.

Among the two types of conventional contact image sensor 1 mentioned above, the one shown in FIG. 1 employs expensive color filters, while the packaging cost is also quite high. In addition, when scanning black-and-white objects, the conventional two types of scanning technologies require alternating scans due to the color separation of color filter. Therefore, the speed for scanning colorful objects is the same as the speed for scanning black-and-white objects, which is rather redundant. Since in everyday applications, the scanners are often used to scan black-and-white objects, this redundancy is indeed unnecessary.

The contact image sensor as shown in FIG. 2 employs a light emitting diode as the light source. In addition to the above drawbacks, the light source composed of the light emitting diodes has a weaker brightness, while the light intensity is severely decayed after transmitting through the lightguide. It takes longer time to accumulate the required energy to trigger the sensor.

### BRIEF SUMMARY OF THE INVENTION

The present invention is to provide a contact image scanning module that can employ light sources of different properties and a switching control circuit to switch between light sources when making black-and-white and colorful scans, so as to provide different scanning speeds when scanning different objects, thereby enhancing the black-and-white scanning speed.

In order to achieve the above and other objectives, the contact image scanning module having multiple light sources of the present invention includes:

a housing for assemble therein a plurality of module elements;

at least two light source groups that provides scanning light sources of different properties, so as to generate a reflected image of the object on the scanning flatbed;

at least a switching control circuit for switching and controlling the two light source groups in accordance with the property of the object to be scanned to provide different scanning speeds;

at least a lens element for receiving the reflected image and for generating a focused image;

at least an optical sensor for receiving the focused image and converting the optical signals into electronic signals; and

a scanning flatbed for placing the object to be scanned thereon to perform scanning operations.

### BRIEF DESCRIPTION OF THE DRAWINGS

FIG. 1 illustrates a structure diagram of a conventional contact image scanning module.

FIG. 2 illustrates a structure diagram of another conventional contact image scanning module.

FIG. 3 illustrates a structure diagram of a contact image scanning module, in accordance with one embodiment of the present invention.

FIG. 4 illustrates a structure diagram of a contact image scanning module, in accordance with another embodiment of the present invention.

FIG. 5 illustrates a structure diagram of the first light source group, in accordance with one embodiment of the present invention.

FIG. 6 illustrates a structure diagram of a contact image scanning module, in accordance with still another embodiment of the present invention.

FIG. 7 illustrates a structure diagram of the second light source group, in accordance with one embodiment of the present invention.

FIG. 8 is a sectional view of FIG. 7.

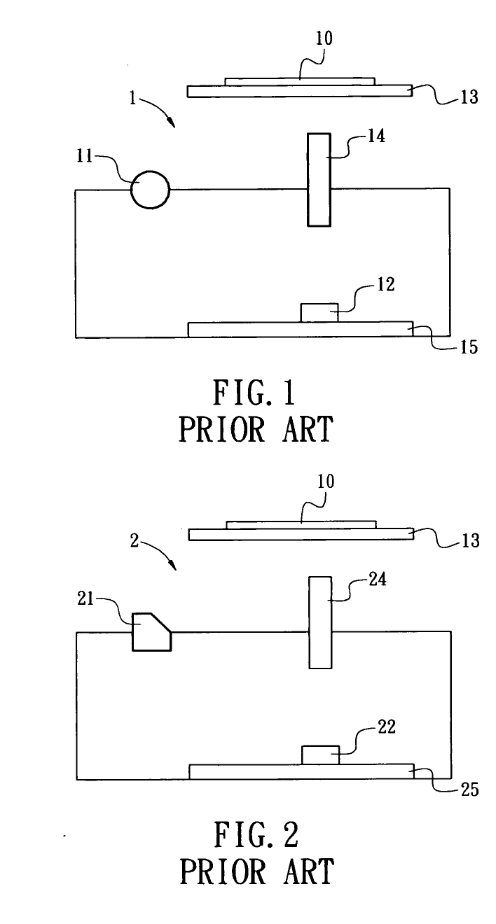

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

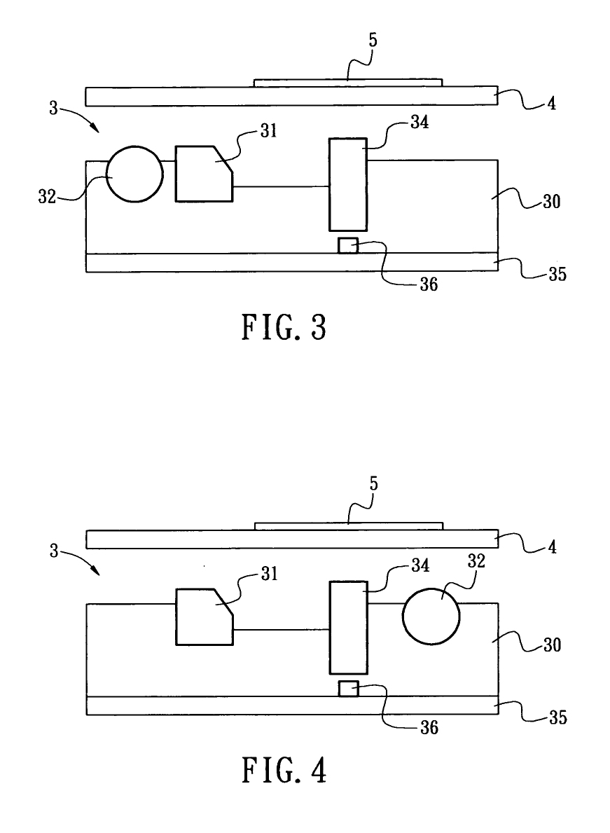

Referring to FIG. 3 to FIG. 5, a preferred embodiment of the contact image scanning module having multiple light sources is illustrated. The contact image scanning module 3 includes a housing 30, two or more light source groups 32, 33 disposed at two predetermined locations in the housing 30, at least a switching control circuit (not shown) for controlling the two light source groups 31, 32 to scan the objects 5 to be scanned with various speeds and generating the reflected image of the object to be scanned 5 on a scanning flatbed 4, at least a lens element 34 for receiving the reflected image and generating a focused image, and at least an optical sensor 36 for receiving the focused image from the lens element 34 and converting the focused image into electronic signals, as shown in FIG. 3.

The housing 30 described above, in one particular embodiment of the present invention, can be of any form such that the at least two light sources 31, 32, the lens element 34, the at least a switching control circuit, the printed circuit board 35, and the at least an optical sensor 36 are assembled therein.

In the present invention, the light source groups 31, 32 can be a cold cathode fluorescent lamp (CCFL), a light emitting diode, a halogen light source, a cathode fluorescent lamp (CFL), an organic light emitting diode (OLED), or a polymer light emitting diode (PLED). The light source groups 31, 32 can be embedded, glued, or skewed in the predetermined positions of the housing 30 described above.

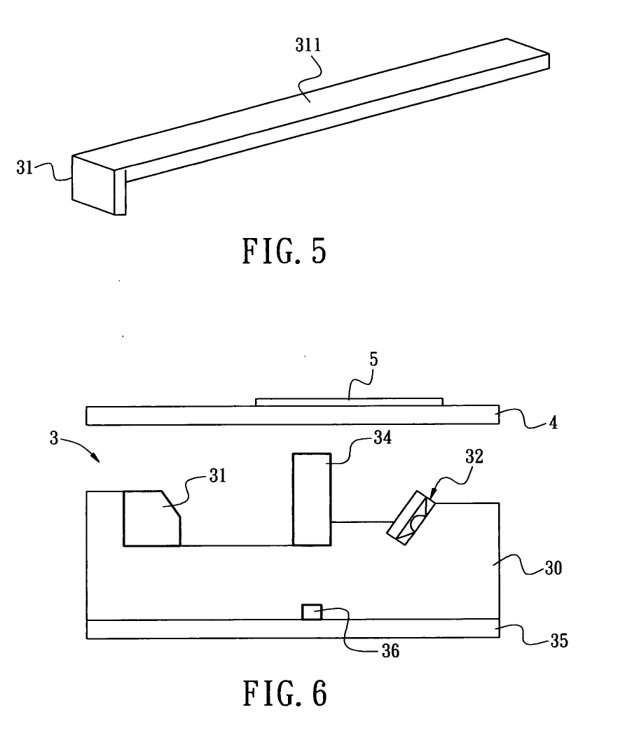

The two light source groups 31, 32, in this particular embodiment of the present invention shown in FIG. 3, include a first light source group 31, which employs at least a light source having the RGB colors and incorporates with a lightguide 311 making the brightness homogeneous, as shown in FIG. 5, thereby supplying the colorful scanning light source relative to the object 5 to be scanned; and a second light source group 32, which employs a monochrome high brightness light source, such as a CCFL, an LED, a halogen light source, a cathode fluorescent lamp, an OLED, or a PLED, thereby supplying the black-and-white light source relative to the object 5 to be scanned

The first light source group 31 and the second light source group 32, in one particular embodiment of the present invention, are disposed to the same side of the lens element 34, as shown in FIG. 3. The two light sources 31, 32 can also be disposed at two different sides of the lens element 34 as shown in FIG. 4, so as to scan the object 5 to be scanned on the scanning flatbed 4 and generate the reflected image.

The switching control circuit (not shown) described above is electrically connected to the first light source group 31 and the second light source group 32, thereby controlling the first light source group 31 and the second light source group 32 to switch on and off according to the particular object to be scanned 5. In this manner, the reflected images can be generated by different light sources according to the objects to be scanned 5 with different scanning speeds.

The lens element 34 described above, in one particular embodiment of the present invention, employs a cylindrical lens, which is disposed in the housing 30 by means of embedding, gluing or skewing, so as to receive the reflected image from the first light source group 31 or the second light source group 32 and generate a focused image, so as to form an image on the at least an optical sensor 36.

The at least an optical sensor 36 described above receives the focused image from the lens element 34 and converts the optical signals into electronic signals. The optical sensor 36 in one particular embodiment is a CCD or a CMOS.

The printed circuit board 35 having the switching control circuit and the optical sensor 36 disposed thereon is a modulized element disposed in the housing 30, so as to form, together with the scanning flatbed 4, a contact image sensor having multiple light sources.

The scanning flatbed 4 is disposed at the top portion of the housing 30. In one preferred embodiment of the present invention, the scanning flatbed 4 is a piece of transparent glass to provide a flat surface for positioning an object to be scanned 5 thereon, thereby scanning the object 5 using the first light source group 31 or the second light source group 32

The contact image scanning module of the present invention uses the at least a switching control circuit to turn on the first light source group 31 and the second light source group 32, or to turn on only the monochrome high brightness second light source group 32, when performing a black-and-white scan to the object to be scanned 5. After the light source is shined on the object 5, a reflected image is generated and reflected to the lens element 34 to form a focused image. The focused image is formed on the optical sensor 36, and converted to electronic signals. When performing a colorful scan to the object to be scanned 5, the switching control circuit turns on the first light source group 31 of RGB colors, and turns of the second light source group 32 of monochrome high brightness. Only the colorful light source is shined on the object to be scanned 5. A reflected image of RGB colors is thus generated and reflected to the lens element 34 to generate a focused image. The focused image is formed on the optical element 36 and converted to electronic signals. In this manner, the first light source group 31 or the second light source group 32 can be turned on to scan the object 5 according to the need of a black-and-white or colorful scan. In contrast to the conventional scanning module having only a single light source, the present invention can perform scan operations using various scanning speeds, which can largely enhance the scanning speed for black-and-white scans.

Referring again to FIG. 6 to FIG. 8, another preferred embodiment of the present invention is illustrated. The contact image scanning module 3, as shown in FIG. 6, also includes a housing 30, a first light source group and a second light source group 32 disposed at two predetermined locations in the housing 30, at least a switching control circuit (not shown) for controlling the two light source groups 31, 32 to scan objects to be scanned 5 with various speeds and generating the reflected image of the object to be scanned 5 on a scanning flatbed 4, at least a lens element 34 for receiving the reflected image and generating a focused image, and at least an optical sensor 36 for receiving the focused image from the lens element 34 and converting the focused image into electronic signals.

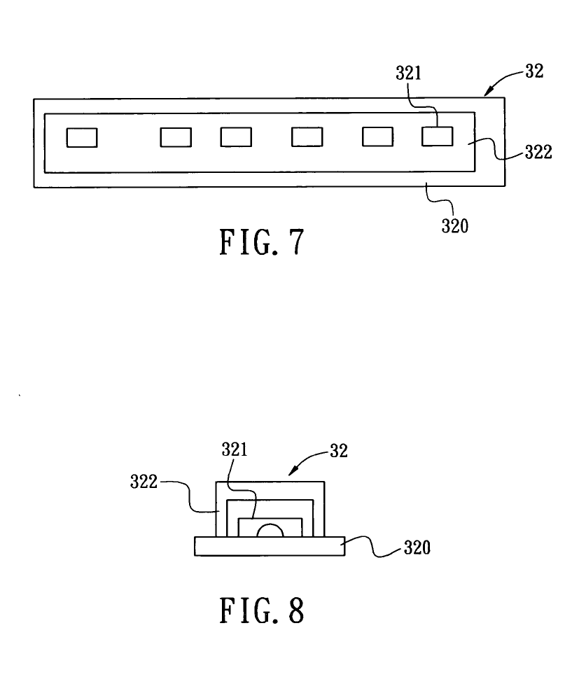

The first light source group 31 and the second light source group 32 described above also employ at least a light source of RGB colors and incorporate with a lightguide 311 so as to make the brightness homogeneous, as shown in FIG. 5, thereby supplying the colorful scanning light source relative to the object 5 to be scanned. The second light source group 32 employs one or more monochrome high brightness light source 321, such as a CCFL, an LED, a halogen light source, a cathode fluorescent lamp, an OLED, or a PLED, which is securely disposed on a printed circuit board 320. The quantity of the light source element 321 depends on the actual need. One can further incorporate a diffuser 322 to make the brightness more homogeneous, as shown in FIG. 7 and FIG. 8, thereby supplying the black-and-white light source to the object 5 to be scanned.

Similarly, the contact image scanning module having multiple light sources in accordance with the second embodiment of the present invention employs the first light source group 31 and the second light source group 32 of different properties and incorporates with a switching control circuit to switch between light sources when scanning black-and-white and colorful objects 5, whereby the object 5 can be scanned with different scanning speed, which enhances the black-and-white scanning speed.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A contact image scanning module having multiple light sources, comprising:
at least two light source groups that provide scanning light sources of different properties;
at least a lens element for receiving a reflected image and generating a focused image;
at least a printed circuit board;
at least a switching control circuit for switching and controlling the light source groups in accordance with the property of the object to be scanned to provide different scanning speeds; and
at least an optical sensor for receiving the focused image and converting to electronic signals.

2. The module as recited in claim 1, wherein the light source group is one selected from a cold cathode fluorescent lamp, a light emitting diode, a halogen light source, a cathode fluorescent lamp, an organic light emitting diode, and a polymer light emitting diode.

3. The module as recited in claim 1, wherein the light sources is disposed in the housing by means of embedding, gluing or skewing.

4. The module as recited in claim 1, wherein the light sources comprises a first light source group, which is at least a light emitting diode, an organic light emitting diode or a polymer light emitting diode of red green and blue colors, and a second light source group, which is a monochrome high brightness light source element, such as a cold cathode fluorescent lamp, an light emitting diode, a halogen light source, a cold fluorescent lamp, an organic light emitting diode, and a polymer light emitting diode.

5. The module as recited in claim 4, wherein the first light source group comprises a light guide for making the light brightness homogeneous.

6. The module as recited in claim 4, wherein the second light source group comprises means for making light brightness homogeneous.

7. The module as recited in claim 1, wherein the light source groups are disposed at the same side or at different sides relative to the lens element

8. The module as recited in claim 1, wherein the lens element comprises a cylindrical lens being disposed in the housing.

9. The module as recited in claim 1, wherein the optical sensor is a charge coupled device or a complimentary metal-oxide semiconductor.

10. The module as recited in claim 1, further comprises a housing for assembling therein the light sources, the lens element, the printed circuit board and the optical sensor.

11. A contact image scanning module having multiple light sources, comprising:
a first light source group providing light sources for color scans;
a second light source group providing light sources for black-and-white scans;
at least a lens element for receiving the reflected image and generating a focused image;
at least a printed circuit board providing circuits and elements to dispose thereon;
at least a switching control circuit for switching and controlling the two light source groups in accordance with the property of the object to be scanned to provide different scanning speeds; and
at least an optical sensor for receiving the focused image and converting to electronic signals.

12. The module as recited in claim 1 1, wherein the second light source group comprises at least a monochrome high brightness light source element, such as a light emitting diode, an organic light emitting diode, a polymer light emitting diode that emits monochrome light, the light source element being disposed on a printed circuit board, wherein the quantity of the light source element depends on the actual need.

13. The module as recited in claim 11, wherein the second light source group further includes means for making light brightness homogenous, which is disposed relative to at least a light source element on the printed circuit board.
